(19) United States
(12) Patent Application Publication
(10) Pub. No.: US 2005/0289343 A1
(43) Pub. Date: Dec. 29, 2005

(54) Systems and methods for binding a hardware component and a platform

(75) Inventor: Thomas Tahan, San Diego, CA (US)

Correspondence Address: Michael K. Hsu;MARTINE & PENILLA, LLP, Suite 200, 710 Lakeway Drive, Sunnyvale, CA, 94085, US

(73) Assignee: SUN MICROSYSTEMS, INC., SANTA CLARA, CA (US)

(21) Appl. No.: 10/982,332

(22) Filed: Nov. 4, 2004

Related U.S. Application Data
(60) Provisional application No. 60/582,569, filed on Jun. 23, 2004.

(51) Int. Cl. H04L 9/00

(52) U.S. Cl. 713/169

(57) ABSTRACT

A hardware-based method for binding a hardware component and a platform is provided. In this hardware-based method, a cryptographic binding is established between the hardware component and the platform. The cryptographic binding is the registration of cryptographic keys between the hardware component and the platform. Subsequently, an identity exchange is performed between the hardware component and the platform using the cryptographic keys as inputs to cryptographic operations, where the identity exchange enables a challenger to verify the identity of a responder. A hardware component to be bound with a platform, a platform identity module, and a system for binding a hardware component and a platform also are described.

### CROSS REFERENCE TO RELATED APPLICATIONS

This application claims the benefit of U.S. Provisional Application No. 60/582,569, filed Jun. 23, 2004. The disclosure of the provisional application is incorporated herein by reference.

### BACKGROUND OF THE INVENTION

1. Field of the Invention

The present invention relates generally to hardware security and, more particularly, to methods and systems for binding a hardware component and a platform.

2. Description of the Related Art

Platforms are generally designed with some fixed hardware components that are physically bound (e.g., soldered) to the platform, and with some hardware components that can be removed. In certain situations, especially when removable hardware components contain sensitive information or exchange sensitive information with the platform, they need to be bound to the platform such that the hardware components cannot be removed from the platform and used in another platform or system that would allow the sensitive information to be used, exposed, or modified. Even when hardware components cannot be physically removed from a platform, it is necessary in some situations to bind them with the platform to counter certain design vulnerabilities.

A conventional method to bind a hardware component and the platform is to store identical random numbers in a platform memory and in the hardware component. When the platform boots, the random numbers in both the platform memory and the hardware component are retrieved and compared. If the random numbers match, then the correct hardware component is supposedly attached to the correct platform. If the random numbers do not match, then the approved matching between the hardware component and the platform has been compromised.

A disadvantage of the conventional method to bind the hardware component and the platform is that the random numbers are not secured. As a result, the unsecured random numbers can easily be read from the platform memory and the hardware component. Accordingly, with easy access to the random numbers, the pairing between the hardware component and the platform can easily be spoofed.

In view of the foregoing, there is a need to provide methods and systems for binding a hardware component and a platform.

### SUMMARY OF THE INVENTION

Broadly speaking, the present invention fills these needs by providing systems and methods for binding a hardware component and a platform. It should be appreciated that the present invention can be implemented in numerous ways, including as a process, an apparatus, a system, computer readable media, or a device. Several inventive embodiments of the present invention are described below.

In accordance with a first aspect of the present invention, a hardware-based method for binding a hardware component and a platform is provided. In this hardware-based method, a cryptographic binding is established between the hardware component and the platform. The cryptographic binding is the registration of cryptographic keys between the hardware component and the platform. Subsequently, an identity exchange is performed between the hardware component and the platform using the cryptographic keys as inputs to cryptographic operations, where the identity exchange enables a challenger to verify the identity of a responder.

In accordance with a second aspect of the present invention, a platform identity module (PIM) for binding a hardware component and a platform is provided. The PIM includes logic for establishing a cryptographic binding between the hardware component and the PIM. In this embodiment, the cryptographic binding is the registration of cryptographic keys between the hardware component and the PIM. The PIM also includes logic for performing an identity exchange between the hardware component and the PIM using the cryptographic keys as inputs to cryptographic operations.

In accordance with a third aspect of the present invention, a hardware component to be bound with a platform is provided. The hardware component includes logic for establishing a cryptographic binding between the platform and the hardware component. In this embodiment, the cryptographic binding is the registration of cryptographic keys between the platform and the hardware component. The hardware component additionally includes logic for performing an identity exchange between the platform and the hardware component using the cryptographic keys as inputs to cryptographic operations.

In accordance with a fourth aspect of the present invention, a system for binding a hardware component and a platform is provided. The system includes a platform that includes logic for establishing a cryptographic binding between the hardware component and the platform. In this embodiment, the cryptographic binding is the registration of cryptographic keys between the hardware component and the platform. The platform also includes logic for performing an identity exchange between the hardware component and the platform using the cryptographic keys as inputs to cryptographic operations. The system additionally includes the hardware component in communication with the platform.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1 is a simplified block diagram of a system for binding a hardware component and a platform, in accordance with one embodiment of the present invention.

FIG. 2 is a flowchart diagram of a high level overview of a hardware-based method for binding a hardware component and a platform, in accordance with one embodiment of the present invention.

FIGS. 3A, 3B, and 3C are simplified block diagrams of various embodiments for establishing a cryptographic binding between a hardware component and a platform.

FIG. 4 is a simplified block diagram of a more detailed overview for performing a platform identity exchange between a hardware component and a platform allowing the hardware component to validate the identity of the platform using the cryptographic keys as inputs to cryptographic operations, in accordance with one embodiment of the present invention.

FIG. 5 is a simplified block diagram of another, more detailed overview for performing a component identity exchange between a platform and a hardware component allowing the platform to validate the identity of the hardware component using the cryptographic keys as inputs to cryptographic operations, in accordance with one embodiment of the present invention.

### DETAILED DESCRIPTION

An invention is disclosed for systems and methods for binding a hardware component and a platform. In the following description, numerous specific details are set forth in order to provide a thorough understanding of the present invention. It will be understood, however, by one of ordinary skill in the art, that the present invention may be practiced without some or all of these specific details. In other instances, well known process operations have not been described in detail in order not to unnecessarily obscure the present invention.

The embodiments described here provide methods and systems for binding a hardware component and a platform. Essentially, the invention uses cryptographic methods to bind the hardware component and the platform. In effect, the invention employs cryptographic techniques that protect against circumvention by an attacker. As will be explained in more detail below, a cryptographic binding between the hardware component and the platform is first established. Subsequently, to verify that the hardware component is attached to the platform, one or more identity exchanges are performed.

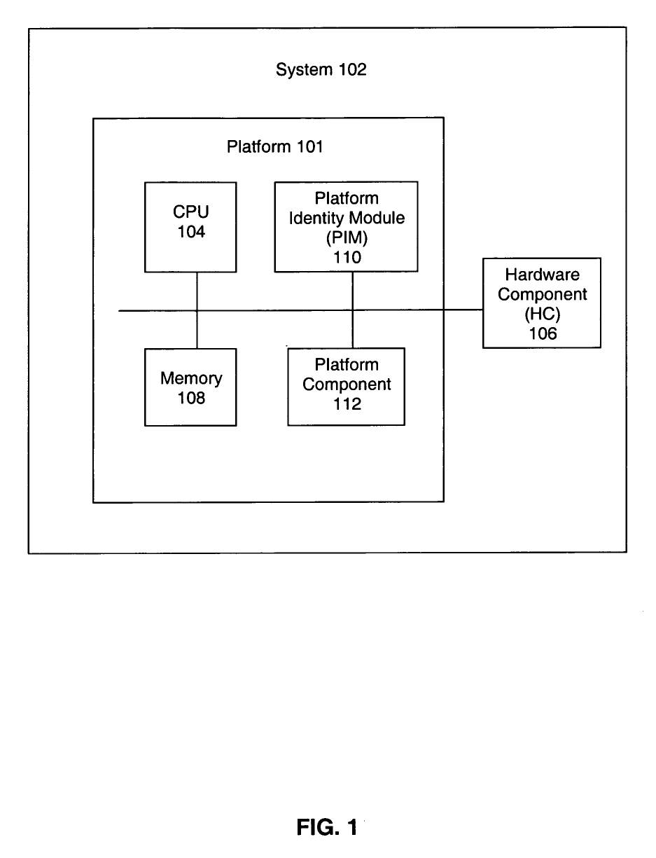

FIG. 1 is a simplified block diagram of a system for binding a hardware component and a platform, in accordance with one embodiment of the present invention. As shown in FIG. 1, system 102 includes platform 101 that includes central processing unit (CPU) 104, memory 108, platform identity module (PIM) 110, and platform component 112. System 102 also includes hardware component 106. One skilled in the art will appreciate that while CPU 104, memory 108, PIM 110, platform component 112, and hardware component 106 are illustrated as being interconnected, each of these components may be in communication through a common bus or multiple buses or interconnects. Hardware component 106 may be able to directly communicate with PIM 110, or the communications may be routed through CPU 104 or platform component 112. CPU 104 includes any suitable processors. Exemplary processors include Scalable Processor Architecture (SPARC) processors, Pentium processors, PowerPC processors, Opteron processors, Xeon processors, Itanium processors, etc. Examples of memory 108 include any suitable memory types, such as static access memory (SRAM), dynamic random access memory (DRAM), etc. Hardware component 106 may include any hardware component within system 102, including those that are capable of being removed from the system. Exemplary hardware component 106 includes a chip, a peripheral component interconnect (PCI) card, a PCI-X card, a PCI-Express card, an infiniband terminal communications adapter, a mezzanine card, a network appliance, a platform, a storage system, a storage subsystem, a printer, a keyboard, a mouse, a mobile phone, a personal data assistant, a service processor provided to allow management of the platform, a peripheral, etc. As will be explained in more detail below, in support of some of the identity exchanges, hardware component 106 may store keys, such as private or secret keys, in its memory. Accordingly, hardware component 106 protects the keys and prevents the keys from exposure to or modification by platform 101, other computing components, or unauthorized personnel.

PIM 110 can be any suitable hardware component with a secure cryptographic key store and a cryptographic engine configured to operate on keys. PIM 110 protects the keys in its key store from exposure to or modification by software running in CPU 104, other platform component 112, or unauthorized personnel. An example of PIM 110 that includes a secure cryptographic key store and a cryptographic engine is a trusted platform module (TPM). One skilled in the art will appreciate that the TPM is a security component specified by the Trusted Computing Group, and the TPM typically provides a secure boot capability for a platform, as well as a protected storage capability for storing sensitive information such as cryptographic keys. Another example of PIM 110 include a Federal Information Processing Standards (FIPS) 140-2 compliant cryptographic module. PIM 110 is physically attached to a part of platform 101 that is physically identified as belonging to the platform. Exemplary locations for PIM 110 include a system board (e.g., motherboard or backplane board) and another platform that is physically attached to platform 101, such as a platform management module (i.e., service processor). PIM 110 may be physically attached to platform 101 by soldering or by a strong adhesive which would leave detectable evidence upon the removal of the PIM.

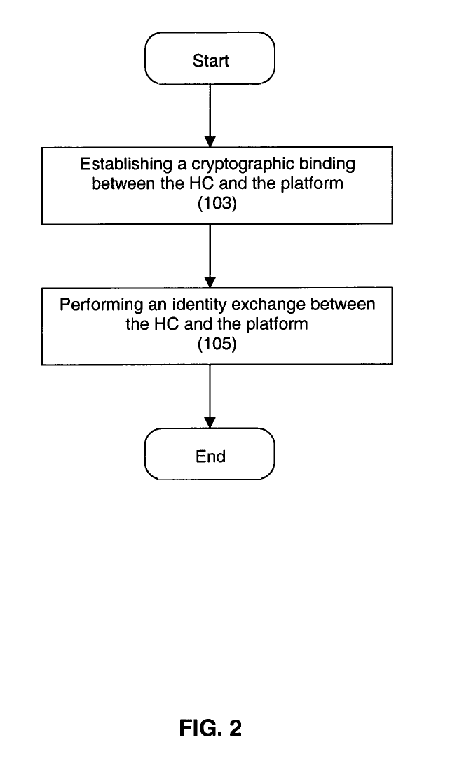

FIG. 2 is a flowchart diagram of a high level overview of a hardware implemented method for binding a hardware component and a platform, in accordance with one embodiment of the present invention. Starting in operation 103, a cryptographic binding between the hardware component and the platform is established. As will be explained in more detail below, the cryptographic binding involves registration of cryptographic keys between the hardware component and the platform. Subsequently, identity exchanges are performed between the hardware component and the platform in operation 105 using the cryptographic keys as inputs to cryptographic operations (i.e., encryption, decryption, or one-way hash computations). Two identity exchanges may be performed: (1) a platform identity exchange, allowing the hardware component to verify the identity of the platform to which the hardware component is attached, and (2) a component identity exchange, allowing the platform to verify the identity of the attached hardware component. Essentially, as will be explained below, in the identity exchanges (i.e., platform identity exchange and the component identity exchange), a challenger (either the hardware component or the platform) transmits a challenge containing a nonce to a responder (either the platform or the hardware component). A nonce is an unique numeric value. The party receiving the challenge performs a cryptographic operation on the nonce within the challenge and returns the result. If the challenger's validation of the result succeeds, the identity of the responder is confirmed and the challenger enters a state allowing full interoperation with the responder. If the validation fails, the challenger will restrict operations with the responder, according to an established policy. In one embodiment, the identity exchanges are performed after a system reset when the platform and the hardware component are initializing. In another embodiment, the identity exchanges may be performed any time after the hardware component or platform has entered fully operational state for further verification that the binding between the hardware component and the platform is still valid.

I. Establishing a Cryptographic Binding

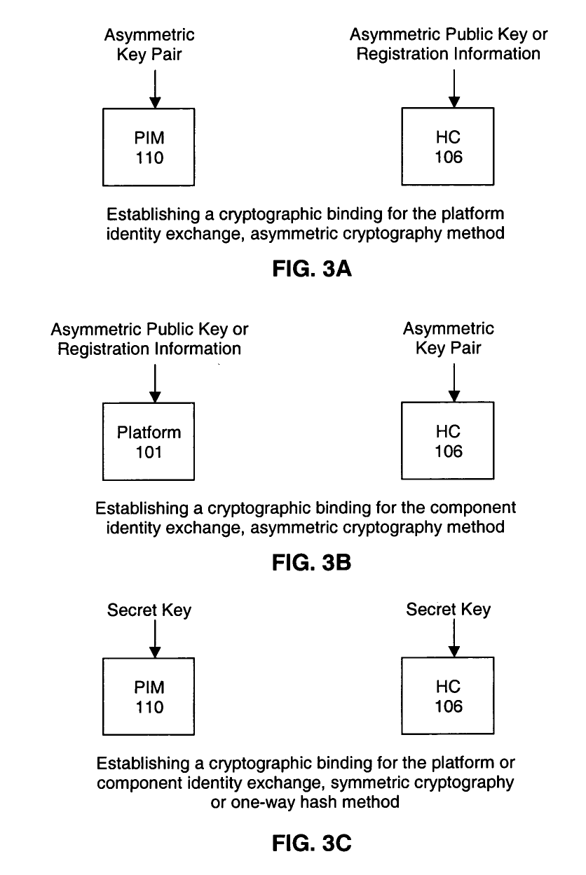

FIGS. 3A, 3B, and 3C are simplified block diagrams of various embodiments for establishing a cryptographic binding between the hardware component and the platform. As will be explained in more detail below, in an identity exchange between the hardware component and the platform, either an asymmetric cryptographic algorithm, a symmetric cryptographic algorithm, or a one-way hash algorithm can be used. However, cryptographic bindings between the hardware component and the platform are to be first established to enable the identity exchanges. As is known to those skilled in the art, encryption or digital signature using an asymmetric (i.e., public key) cryptographic algorithm is a cryptographic system that uses a public key known to everyone and a private key known to the sender of the message. The public and private keys are related in such a way that the public key can be used to encrypt messages and the corresponding private key can be used to decrypt the messages, or vice versa.

FIG. 3A is a simplified block diagram of the establishment of a cryptographic binding of the platform to the hardware component for a platform identity exchange using an asymmetric cryptography method, in accordance with one embodiment of the present invention. The platform identity exchange provides cryptographic proof of the platform's identity to the hardware component. In one embodiment, PIM 110 within a platform can generate an asymmetric key pair comprising an asymmetric public key and an asymmetric private key. Any suitable asymmetric cryptographic algorithms (e.g., Rivest-Shamir-Adleman (RSA), Digital Signature Algorithm (DSA), Elliptical Curve Cryptography (ECC), etc.) may be used to generate the asymmetric key pair. In another embodiment, the asymmetric key pair may be provided to PIM 110 through a secure administrative path. A secure administrative path is a secure method for a trusted administrator to enter commands, security critical information, and other sensitive information into a security component (e.g., hardware component 106 and PIM 110) such that these information cannot be modified and viewed while being transferred from the administrator to the hardware component and the PIM.

As shown in FIG. 3A, registration information of an asymmetric public key is provided to hardware component 106. In one embodiment, referred to herein as the public key method, the registration information is the asymmetric public key itself, that is provided to hardware component 106 through a secure administrative path when the hardware component is configured.

However, in another embodiment, referred to herein as the digital certificate method, the platform identity exchange may use the asymmetric cryptography method with a digital certificate method. As is known to those skilled in the art, a digital certificate may be used to verify that a sender's reported identity is the same as his actual identity. The digital certificate (or a one-way hash of the certificate components) is digitally signed by a certificate authority (CA) using the CA's asymmetric private key. A CA's asymmetric public key is distributed to parties that are potential users of the certificate over a secure administrative path. The CA's asymmetric public key can later be used by a party to validate that the certificate was signed by the CA. In this embodiment, the asymmetric public key and identifying information (or a hash of the asymmetric public key and the identifying information) of PIM 110 may be digitally signed by CA that is trusted by the platform and hardware component 106. The CA's asymmetric public key, which is associated with the CA's asymmetric private key used to compute the signature of the digital certificate containing PIM 110's asymmetric public key, is provided to hardware component 106 through a secure administrative path when hardware component 106 is configured.

In still another embodiment, referred to herein as the fingerprint method, the platform identity exchange may use the asymmetric cryptography method with a fingerprint method. As is known to those skilled in the art, the fingerprint of a public key may be used to verify the validity of the public key. A fingerprint is essentially a cryptographic function computed over the public key. For example, the fingerprint may be the result of a one-way hash computation or residue from a symmetric cipher over the public key. In this embodiment, a fingerprint value of the asymmetric public key is provided to hardware component 106 through a secure administrative path. Later, as part of the platform identity exchange, the asymmetric public key of the platform will be transmitted to hardware component 106. Hardware component 106 can compute a fingerprint value over the received asymmetric public key and check that that the fingerprint value matches the fingerprint value provided over the secure administrative path in order to validate the received public key.

FIG. 3B is a simplified block diagram of the establishment of a cryptographic binding of the hardware component to the platform for a component identity exchange using an asymmetric cryptography method, in accordance with one embodiment of the present invention. The component identity exchange enables platform 101 to verify the identity of hardware component 106. An asymmetric key pair is generated in hardware component 106 or provided to the hardware component through a secure administrative path. As shown in FIG. 3B, for a public key method, the asymmetric public key of the key pair is provided to platform 101 through a secure administrative path, in accordance with one embodiment of the present invention. In another embodiment, for a digital certificate method as discussed above, the CA's public key, which is associated with the CA's private key used in the signature of the asymmetric public key of hardware component 106, is provided to platform 101 through a secure administrative path when the platform is configured. In still another embodiment, for a fingerprint method as discussed above, a fingerprint value of the asymmetric public key of hardware component 106 is provided to platform 101 through a secure administrative path.

FIG. 3C is a simplified block diagram of the establishment of a cryptographic binding between the hardware component and the platform for an identity exchange using a symmetric cryptography method, in accordance with one embodiment of the present invention. One skilled in the art will appreciate that symmetric cryptography is a type of encryption where the same secret key is used to encrypt and decrypt messages. The secret key is protected such that the secret key is known to the parties using the secret key. Similarly, a secret key can be used as an input to a one-way hash algorithm, and the cryptographic binding shown in FIG. 3C can also be used for an identity exchange using a one-way hash method. In one embodiment, a secret key is provided to both PIM 110 and hardware component 106 through secure administrative paths. In another embodiment, the secret key may be generated in hardware component 106, PIM 110, or a trusted third party with the capability to securely load the secret key into hardware component 106 and PIM 110.

An alternative embodiment for providing the secret key to hardware component 106 and PIM 110 is to use a secret key exchange based on asymmetric cryptography. Examples of such secret key exchanges based on asymmetric cryptography include Diffie-Hellman, Rivest-Shamir-Adleman (RSA), Error Correction Code (ECC), etc. To protect against man in the middle attacks, the asymmetric public key of PIM 110 may be registered with hardware component 106 using the above-described public key method, digital certificate method, or fingerprint method. For bidirectional authentication, the asymmetric public key of hardware component 106 may also be registered with PIM 110, using the above-described public key method, digital certificate method, or fingerprint method.

For a Diffie-Hellman key exchange including bidirectional authentication, both PIM 110 and hardware component 106 generate a Diffie-Hellman key pair, sign the Diffie-Hellman public key using their asymmetric private keys, exchange the signed Diffie-Hellman public keys, and validate the signature on the received Diffie Hellman public keys. If the validations succeed, then both PIM 110 and hardware component 106 compute the secret key using the Diffie-Hellman algorithm.

With RSA, ECC, or other similar asymmetric algorithms, a secret key is generated in hardware component 106, either using the hardware component's random number generator or from an external key generation source securely connected to the hardware component. With the digital certificate or fingerprint method, PIM 110 sends its asymmetric public key, which has been previously registered with hardware component 106 through a secure administrative path, to the hardware component, and the hardware component validates this asymmetric public key. Hardware component 106 uses the asymmetric public key of PIM 110 to encrypt the secret key that the hardware component has generated. PIM 110 then decrypts the secret key using its asymmetric private key. This operation may be done in a CPU or in PIM 110.

When source authentication of the key exchange messages is required, a sender may digitally sign its transmission using its asymmetric private key as input to an asymmetric cryptographic algorithm. The signed message should be unique to the exchange to prevent replay attacks. Verification of the signature by the receiver is performed using a pre-registered asymmetric public key. Source authentication in the key exchange may be unidirectional or bidirectional. In one embodiment, bidirectional authentication may be used for a key exchange between PIM 110 and hardware component 106. As an example exchange with bidirectional authentication, hardware component 106 signs, using an asymmetric private key, a nonce provided by PIM 110. This signature also covers the encrypted secret key sent by hardware component 106. PIM110 validates the asymmetric public key of hardware component 106 using registration information. PIM 110 then validates this signature using the asymmetric public key of hardware component 106. If validation of this signature succeeds, then PIM 110 knows that hardware component 106 sent the secret key. It should be appreciated that the key exchange may be reversed from that described above, with PIM 110 generating the secret key and sending the secret key to hardware component 106.

Once the secret key has been generated and is known by both PIM 110 and hardware component 106, the secret key may be stored in a secure storage in the PIM 110 and the hardware component for subsequent use. An optional, second secret key may be generated, one secret key for each type of identity exchange, as will be explained in more detail below. Alternatively, the same secret key may be used for each type of identity exchange.

Furthermore, for performance reasons, asymmetric encryption is often used in conjunction with a one-way hash function, in accordance with one embodiment of the present invention. One skilled in the art will appreciate that with a one-way hash function, a one-way hash is computed over the data to be signed and the asymmetric algorithm is used to encrypt the result of the one-way hash computation.

II. Performing an Identity Exchange

There are two types of identity exchange between the hardware component and the platform: (1) the platform identity exchange enabling the hardware component to verify the identity of the platform, and (2) the component identity exchange enabling the platform to verify the identity of the hardware component. Each type of identity exchange requires that a cryptographic binding for that identity exchange be previously established as described above.

The hardware component may initiate a platform identity exchange to verify the identity of the platform to which the hardware component is attached whenever the hardware component is being initialized following a reset, but prior to entering a fully operational state. Alternatively, the hardware component may initiate a platform identity exchange at any time after the hardware component is initialized to periodically verify that the identity of the platform to which the hardware component is attached.

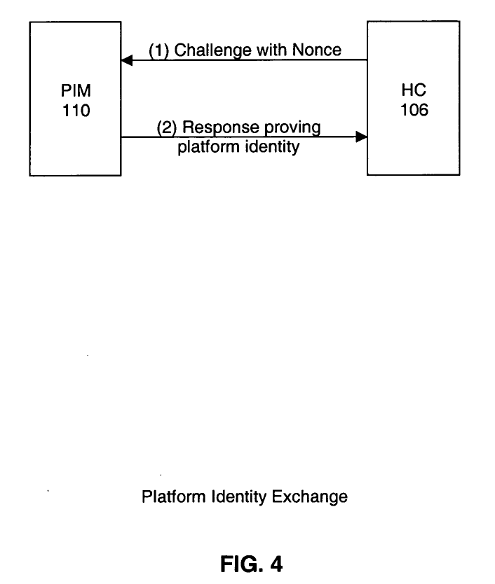

FIG. 4 is a simplified block diagram of a more detailed overview for performing a platform identity exchange between the hardware component and the platform, using the cryptographic keys as inputs to cryptographic operations, in accordance with one embodiment of the present invention. Within a platform, the cryptographic operations for the platform identity exchange are performed within PIM 110. In a platform identity exchange, either an asymmetric cryptographic algorithm, a symmetric cryptographic algorithm, or a one-way hash algorithm can be used to provide hardware component 106 with cryptographically-authenticated proof of platform identity.

In one embodiment, asymmetric cryptography can be used in a platform identity exchange to provide hardware component 106 with cryptographically-authenticated proof of platform identity. As shown in FIG. 4, hardware component 106 first transmits a challenge to the platform. The challenge includes a nonce that has not been used in previous challenges. After receiving the challenge, the platform directs PIM 110 to encrypt the nonce or a value derived from the nonce using its asymmetric private key stored within the PIM as part of establishing the cryptographic binding. It should be appreciated that instead of operating (e.g., encrypting, decrypting, etc.) on a nonce, the operation may be conducted on a value derived from the nonce, in accordance with another embodiment of the present invention.

Thereafter, if the public key method is used, PIM 110 then constructs and outputs a response for hardware component 106 that includes the encrypted nonce to prove the platform identity, in accordance with one embodiment of the present invention. In another embodiment, if the digital certificate method is used, a digital certificate containing the asymmetric public key of PIM 110 and platform identifying information, signed by a Certificate Authority, may additionally be included with the response. In yet another embodiment, if the fingerprint method is used, the asymmetric public key of PIM 110 may additionally be included with the response.

After receiving the response, hardware component 106 validates the response. In one embodiment, if the public key method is used, hardware component 106 uses the asymmetric public key of PIM 110 to decrypt the response. In another embodiment, if the digital certificate method is used, hardware component 106 first validates the digital certificate containing the asymmetric public key of PIM 110 and platform identifying information, using the asymmetric public key of the Certificate Authority that signed the certificate. The validation includes using the Certificate Authority's public key to decrypt the certificate contents or the result of a one-way hash computed over the certificate contents, and if the contents were hashed, validating the hash, and then comparing the platform identifying information in the certificate with that previously registered with hardware component 106. If the certificate validation succeeds, hardware component 106 then uses the asymmetric public key of PIM 110 to decrypt the nonce. In another embodiment, if the fingerprint method is used, hardware component 106 first validates that a fingerprint computed over the asymmetric public key of PIM 110 matches the fingerprint previously registered with the hardware component when the cryptographic binding was established. Hardware component 106 then uses the asymmetric public key of PIM 110 to decrypt the nonce.

Subsequently, in one embodiment, hardware component 106 validates the response by comparing the decrypted nonce with the nonce transmitted in the challenge. If the decrypted nonce matches the nonce transmitted in the challenge, then hardware component 106 has cryptographic proof that the hardware component is attached to the platform to which the hardware component has been bound. If the decrypted nonce does not match the nonce transmitted in the challenge, then hardware component 106 may enter into an exception state in which the hardware component allows a restricted set of operations with the platform.

In another embodiment, symmetric cryptography can be used in a platform identity exchange to provide hardware component 106 with cryptographically-authenticated proof of platform identity. As shown in FIG. 4, hardware component 106 first transmits a challenge to PIM 110. The challenge includes a nonce that has not been used in previous challenges. After receiving the challenge, PIM 110 encrypts the nonce using a secret key and transmits a response to hardware component 106 that includes the encrypted nonce. Hardware component 106 then decrypts the nonce transmitted with the response using the secret key and validates the response. If the decrypted nonce matches the nonce transmitted in the challenge, then hardware component 106 has cryptographic proof that the hardware component is attached to the platform to which the hardware component has been bound. If the decrypted nonce does not match the nonce transmitted in the challenge, hardware component 106 may enter into an exception state in which the hardware component allows a restricted set of operations with the platform.

In still another embodiment, a one-way hash algorithm can be used in a platform identity exchange to provide hardware component 106 with cryptographically-authenticated proof of platform identity. As shown in FIG. 4, hardware component 106 first transmits a challenge to PIM 110. The challenge includes a nonce that has not been used in previous challenges. After receiving the challenge, PIM 110 generates a digest by computing a one-way hash over the nonce and a secret key. PIM 110 then transmits a response to hardware component 106 that includes the digest. After receiving the response, hardware component 106 validates the response by matching the received digest with a digest that the hardware component has computed using the nonce transmitted with the challenge and the secret key. If the received digest matches the digest transmitted in the challenge, then hardware component 106 has cryptographic proof that the hardware component is attached to the platform to which the hardware component has been bound. If the digest does not match the digest transmitted in the challenge, then hardware component 106 may enter into an exception state in which the hardware component allows a restricted set of operations with the platform.

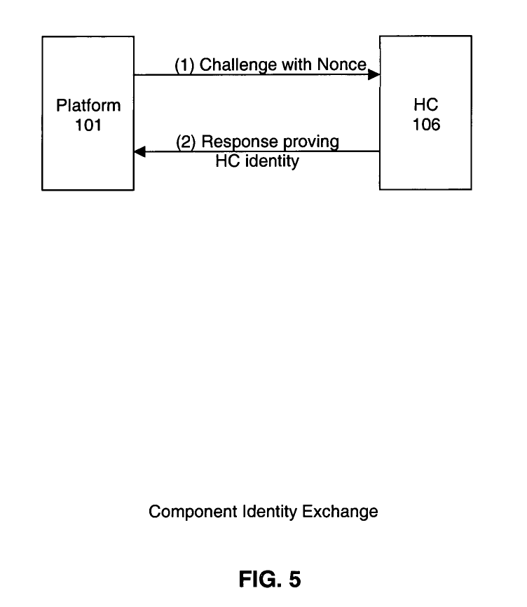

FIG. 5 is a simplified block diagram of another, more detailed overview for performing a component identity exchange allowing the platform to validate the identity of the hardware component using the cryptographic keys as inputs to cryptographic operations, in accordance with one embodiment of the present invention. Cryptographic operations used in the component identity exchange may be either asymmetric cryptography, symmetric cryptography, or one-way hash operations to provide the platform with cryptographically-authenticated proof of identity of hardware component 106. The component identity exchange is essentially the reverse of the platform identity exchange, with the platform transmitting the challenge and hardware component 106 responding, the goal being to authenticate the hardware component's identity to the platform.

In one embodiment, asymmetric cryptography can be used in a component identity exchange to provide platform 101 with cryptographically-authenticated proof of identity of hardware component 106. As shown in FIG. 5, platform 101 first transmits a challenge to hardware component 106 that includes a nonce that has not been used in previous challenges. Any suitable hardware component on platform 101 with processing capability can generate the challenge. Exemplary hardware components include a PIM, a CPU, a programmable gate array (FPGA), an application specific integrated circuit (ASIC), etc

Thereafter, if the public key method is used, hardware component 106 then constructs and transmits a response to platform 101 that includes the encrypted nonce to prove the identity of the hardware component, in accordance with one embodiment of the present invention. In another embodiment, if the digital certificate method used, a digital certificate containing the asymmetric public key of hardware component 106 and hardware component identifying information, signed by a Certificate Authority, may additionally be included with the response. In yet another embodiment, if the fingerprint method is used, the asymmetric public key of hardware component 106 may additionally be included with the response.

After receiving the response, platform 101 validates the response. In one embodiment, if the public key method is used, platform 101 uses the asymmetric public key of hardware component 106 to decrypt the response. In another embodiment, if the digital certificate method is used, platform 101 first validates the digital certificate containing the asymmetric public key of hardware component 106 and hardware component identifying information, using the asymmetric public key of the Certificate Authority that signed the certificate. The validation includes using the Certificate Authority's public key to decrypt the certificate contents or result of a one-way hash computed over the certificate contents, and if the contents were hashed, validating the hash, and then comparing the hardware component identifying information in the certificate with that previously registered with platform 101. If the certificate validation succeeds, platform 101 then uses the asymmetric public key of hardware component 106 to decrypt the nonce. In another embodiment, if the fingerprint method is used, platform 101 first validates that a fingerprint computed over the asymmetric public key of hardware component 106 matches the fingerprint previously registered with platform 101 when the cryptographic binding was established. Platform 101 then uses the asymmetric public key of hardware component 106 to decrypt the nonce.

Subsequently, in one embodiment, platform 101 validates the response by comparing the decrypted nonce with the nonce transmitted in the challenge. If the decrypted nonce matches the nonce transmitted in the challenge, then platform 101 has cryptographic proof that the platform is attached to hardware component 106 to which it has been bound. If the decrypted nonce does not match the nonce transmitted in the challenge, then platform 101 may enter into an exception state in which platform 101 allows a restricted set of operations with hardware component 106.

In another embodiment, symmetric cryptography can be used in a component identity exchange to provide platform 101 with cryptographically-authenticated proof of identity hardware component 106. As shown in FIG. 5, platform 101 first transmits a challenge to hardware component 106. The challenge includes a nonce that has not been used in previous challenges. After receiving the challenge, hardware component 106 encrypts the nonce using a secret key and transmits a response to platform 101 that includes the encrypted nonce. Platform 101 then decrypts the nonce transmitted with the response using the secret key and validates the response. If the decrypted nonce matches the nonce transmitted in the challenge, then platform 101 has cryptographic proof that the platform is attached to hardware component 106 to which the platform has been bound. If the decrypted nonce does not match the nonce transmitted in the challenge, platform 101 may enter into an exception state in which the platform allows a restricted set of operations with hardware component 106.

In still another embodiment, a one-way hash algorithm can be used in a component identity exchange to provide platform 101 with cryptographically-authenticated proof of hardware component 106 identity. As shown in FIG. 5, platform 101 first transmits a challenge to hardware component 106. The challenge includes a nonce that has not been used in previous challenges. After receiving the challenge, hardware component 106 generates a digest by computing a one-way hash over the nonce and a secret key. Hardware component 106 then transmits a response to platform 101 that includes the digest. After receiving the response, platform 101 validates the response by matching the received digest with a digest that the platform has computed using the nonce transmitted with the challenge and the secret key. If the received digest matches the digest transmitted in the challenge, then platform 101 has cryptographic proof that the platform is attached to hardware component 106 to which the platform has been bound. If the digest does not match the digest transmitted in the challenge, then platform 101 may enter into an exception state in which the platform allows a restricted set of operations with hardware component 106.

It should be appreciated that authentication may be bidirectional, with a platform identity exchange and a component identity exchange operating in opposite directions. As such, in one embodiment, bidirectional authentication includes the two identity exchanges described in FIG. 4 and FIG. 5. However, with unidirectional authentication, either the platform identify exchange described in FIG. 4 or the component identity exchange in the opposite direction described in FIG. 5 may be used, in accordance with another embodiment of the present invention.

The functionality described above for binding an hardware component to a platform may be incorporated into any suitable hardware components. For example, returning to FIG. 1, in one embodiment, PIM 110 may include logic for establishing a cryptographic binding between the hardware component and the PIM and logic for performing an identity exchange between the hardware component and the PIM using the cryptographic keys as inputs to cryptographic operations. It will be apparent to one skilled in the art that the functionality described herein may be synthesized into firmware through a suitable hardware description language (HDL). For example, the HDL (e.g., VERILOG) may be employed to synthesize the firmware and the layout of the logic gates for providing the necessary functionality described herein to provide a hardware implementation of the hardware component-platform binding techniques and associated functionalities. Thus, the embodiments described herein may be captured in any suitable form or format that accomplishes the functionality described herein and is not limited to a particular form or format.

Additionally, any of the operations described herein that form part of the invention can be performed by any suitable structural “means” that provide capability for performing the recited functionality. For instance, an exemplary system for binding hardware component and platform includes means for establishing a cryptographic binding between the hardware component and the platform and means for performing an identity exchange between the hardware component and the platform using the cryptographic keys as inputs to cryptographic operations.

In summary, the above-described invention provides methods and systems for binding a hardware component and a platform. When compared to the conventional method of comparing random numbers, the establishment of a cryptographic binding results in a more secure binding of the hardware component and the platform.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data which can be thereafter read by a computer system. The computer readable medium also includes an electromagnetic carrier wave in which the computer code is embodied. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion.

The above described invention may be practiced with other computer system configurations including hand-held devices, microprocessor systems, microprocessor-based or programmable consumer electronics, minicomputers, mainframe computers and the like. Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims.

1. A hardware-based method for binding a hardware component and a platform, comprising method operations of:
establishing a cryptographic binding between the hardware component and the platform, the cryptographic binding being registration of cryptographic keys between the hardware component and the platform; and
performing an identity exchange between the hardware component and the platform using the cryptographic keys as inputs to cryptographic operations, the identity exchange enabling a challenger to verify the identity of a responder.

2. The method of claim 1, further comprising:
restricting interoperation between the hardware component and the platform if the verification of the identity of the responder does not succeed.

3. The hardware-based method of claim 1, wherein the identity exchange is defined by at least one of a platform identity exchange enabling the hardware component to verify the identity of the platform or a component identity exchange enabling the platform to verify the identity of the hardware component.

4. The hardware-based method of claim 1, further comprising:
generating an asymmetric key pair, the asymmetric key pair comprising a first asymmetric public key and an asymmetric private key.

5. The hardware-based method of claim 1, wherein the method operation of establishing the cryptographic binding between the hardware component and the platform includes,
registering asymmetric public keys.

6. The hardware-based method of claim 5, wherein the method operation of registering the asymmetric public keys includes,
if a public key method is used, providing a first asymmetric public key through a secure administrative path;
if a digital certificate method is used, providing a second asymmetric public key of a certificate authority used to sign a first digital certificate through the secure administrative path, the digital certificate comprising an asymmetric public key and first identifying information; and
if a fingerprint method is used, providing a fingerprint value of the first asymmetric public key through the secure administrative path.

7. The hardware-based method of claim 1, further comprising:
if a digital certificate method is used, including a second digital certificate with transmissions that are signed using an asymmetric private key, the second digital certificate comprising a first asymmetric public key and second identifying information that are signed by a certificate authority; and
if a fingerprint method is used, including a third asymmetric public key with the transmissions that are signed using the asymmetric private key.

8. The hardware-based method of claim 1, wherein the method of operation of establishing the cryptographic binding between the hardware component and the platform includes,
providing a secret key to the hardware component through a first secure administrative path; and
providing a secret key to the platform through a second secure administrative path,
wherein the identity exchange uses one of a symmetric cryptography method and a one-way hash method.

9. The hardware-based method of claim 1, wherein the method operation of establishing the cryptographic binding between the hardware component and the platform includes,
performing a secret key exchange between the hardware component and the platform,
wherein the identity exchange uses one of a symmetric cryptography method and a one-way hash method.

10. The hardware-based method of claim 9, wherein the method operation of performing the secret key exchange includes,
generating the secret key;
storing the secret key;
encrypting the secret key using an asymmetric public key; and
transmitting the encrypted secret key.

11. The hardware-based method of claim 9, wherein the method operation of performing the secret key exchange includes,
receiving an encrypted secret key;
decrypting the encrypted secret key using an asymmetric private key; and
storing the decrypted secret key.

12. The hardware-based method of claim 9, wherein the method operation of performing the secret key exchange includes,
generating a first Diffie-Hellman key pair, the first Diffie-Hellman key pair including a first Diffie-Hellman public key and a first Diffie-Hellman private key;
receiving a second Diffie-Hellman key pair, the second Diffie-Hellman key pair including a second Diffie-Hellman public key and a second Diffie-Hellman private key;
generating the secret key from the first and second Diffie-Hellman private keys and the first and second Diffie-Hellman public keys according to a Diffie-Hellman algorithm; and
storing the secret key.

13. The hardware-based method of claim 9, wherein the method operation of performing the secret key exchange includes,
signing a secret key exchange transmission using an asymmetric private key.

14. The hardware-based method of claim 9, wherein the method operation of performing the secret key exchange includes,
verifying a signed secret key exchange transmission using an asymmetric public key.

15. The hardware-based method of claim 14, wherein the method of operation of
verifying the signed secret key exchange transmission includes, verifying a signature of a certificate authority over a second digital certificate using a second asymmetric public key as input to an asymmetric cryptographic operation; and
checking for a match between second identifying information and first identifying information,
wherein a registration of the asymmetric public key uses a digital certificate method.

16. The hardware-based method of claim 14, wherein the method of operation of verifying the signed secret key exchange transmission includes,
verifying that a fingerprint of a third asymmetric public key matches a fingerprint of the first asymmetric public key,
wherein a registration of the asymmetric public key uses a fingerprint method.

17. The hardware-based method of claim 1, wherein the method operation of performing the identity exchange includes:
receiving a challenge, the challenge including a nonce;
encrypting the nonce using an asymmetric private key as input to an asymmetric cryptographic algorithm, the encryption providing an encrypted nonce; and
transmitting a response, the response including the encrypted nonce,
wherein the identity exchange uses an asymmetric cryptography method.

18. The hardware-based method of claim 1, wherein the method operation of performing the identity exchange includes,
transmitting a challenge, the challenge including a nonce;
receiving a response, the response including an encrypted nonce;
decrypting the response using an asymmetric public key as input to an asymmetric cryptographic algorithm, the decryption providing a decrypted nonce; and
validating the response,
wherein the identity exchange uses an asymmetric cryptography method.

19. The hardware-based method of claim 18, wherein the method operation of validating the response includes,
checking that the decrypted nonce matches a nonce transmitted in a challenge.

20. The hardware-based method of claim 18, wherein the response includes,
if a digital certificate method is used, a second digital certificate comprised of the asymmetric public key and first identifying information; and
if a fingerprint method is used, a third asymmetric public key,
wherein the identity exchange uses an asymmetric cryptography method.

21. The hardware-based method of claim 18, wherein the method operation of validating the response includes,
verifying a signature of a certificate authority over a second digital certificate using second asymmetric public key as input to an asymmetric cryptographic operation; and
checking for a match between second identifying information and first identifying information,
wherein a registration of the asymmetric public key uses a digital signature method.

22. The hardware-based method of claim 18, wherein the method operation of validating the response includes,
verifying that a fingerprint of a third asymmetric public key matches a fingerprint of a first asymmetric public key,
wherein a registration of the asymmetric public key uses a fingerprint method.

23. The hardware-based method of claim 1, wherein the method operation of performing the identity exchange includes,
receiving a challenge, the challenge including a nonce;
encrypting the nonce using a secret key as input to a symmetric cryptographic algorithm, the encryption providing an encrypted nonce;
transmitting the encrypted nonce as a response,
wherein the identity exchange uses a symmetric cryptography method.

24. The hardware-based method of claim 1, wherein the method operation of performing the identity exchange includes,
transmitting a challenge, the challenge including a nonce;
receiving a response, the response including an encrypted nonce;
decrypting the response using a secret key as input to a symmetric cryptographic algorithm, the decryption providing a decrypted nonce; and
validating the response,
wherein the identity exchange uses a symmetric cryptography method.

25. The hardware-based method of claim 24, wherein the method operation of validating the response includes,
checking that the decrypted nonce matches the nonce transmitted in a challenge.

26. The hardware-based method of claim 1, wherein the method operation of performing the identity exchange includes,
receiving a challenge, the challenge including a nonce;
computing a first digest using a one-way hash algorithm computed over the nonce and a secret key;
transmitting the first digest as a response,
wherein the identity exchange uses a one-way hash method.

27. The hardware-based method of claim 1, wherein the method operation of performing the identity exchange includes,
transmitting a challenge, the challenge including a nonce;
receiving a response, the response including a first digest;
computing a second digest using a one-way hash algorithm computed over the nonce and a secret key; and
validating the response,
wherein the identity exchange uses a one-way hash method.

28. The hardware-based method of claim 27, wherein the method operation of validating the response includes,
checking that the first digest matches the second digest.

29. A platform identity module (PIM) for binding a hardware component and a platform, comprising:
logic for establishing a cryptographic binding between the hardware component and the PIM, the cryptographic binding being registration of cryptographic keys between the hardware component and the PIM; and
logic for performing an identity exchange between the hardware component and the PIM using the cryptographic keys as inputs to cryptographic operations, the identity exchange enabling a challenger to verify the identity of a responder.

30. The PIM of claim 29, wherein the logic for establishing the cryptographic binding between the hardware component and the PIM includes,
logic for registering asymmetric public keys.

31. The PIM of claim 29, wherein the logic for establishing the cryptographic binding between the hardware component and the PIM includes,
logic for providing a secret key to the PIM through a secure administrative path,
wherein the identity exchange uses one of a symmetric cryptography method and a one-way hash method.

32. The PIM of claim 29, wherein logic for establishing the cryptographic binding between the hardware component and the PIM includes,
logic for performing a secret key exchange between the hardware component and the PIM,
wherein the identity exchange uses one of a symmetric cryptography method and a one-way hash method.

33. The PIM of claim 32, wherein the logic for performing the secret key exchange includes,
logic for receiving an encrypted secret key;
logic for decrypting the encrypted secret key using an asymmetric private key; and
logic for storing the secret key.

34. The PIM of claim 32, wherein the logic for performing the secret key exchange includes,
logic for receiving an asymmetric public key; and
logic for validating an asymmetric public key using asymmetric public key registration information.

35. The PIM of claim 29, wherein the logic for performing the identity exchange includes,
logic for receiving a challenge from the hardware component, the challenge including a nonce;
logic for encrypting the nonce using an asymmetric private key as input to an asymmetric cryptographic algorithm; and
logic for transmitting a response to the hardware component, the response including the encrypted nonce,
wherein the identity exchange is a platform identity exchange that uses an asymmetric cryptography method.

36. The PIM of claim 29, wherein the logic for performing the identity exchange includes,
logic for transmitting a challenge to a hardware component, the challenge including a nonce;
logic for receiving a response from the hardware component, the response including an encrypted nonce;
logic for decrypting the response using an asymmetric private key as input to an asymmetric cryptographic algorithm, the decryption providing the nonce; and
logic for validating the response,
wherein the identity exchange is a component identity exchange that uses an asymmetric cryptography method.

37. The PIM of claim 29, wherein the logic for performing the identity exchange includes,
logic for receiving an asymmetric public key; and
logic for validating an asymmetric public key using asymmetric public key registration information,
wherein the identity exchange uses an asymmetric cryptography method.

38. The PIM of claim 29, wherein the logic for performing the identity exchange includes,
logic for receiving a challenge from the hardware component, the challenge including a nonce;
logic for encrypting the nonce using a secret key as input to a symmetric cryptographic algorithm, the encryption providing an encrypted nonce; and
logic for transmitting a response to the hardware component, the response including the encrypted nonce,
wherein the identity exchange is a platform identity exchange that uses a symmetric cryptography method.

39. The PIM of claim 29, wherein the logic for performing the identity exchange includes,
logic for transmitting a challenge to the hardware component, the challenge including a nonce;
logic for receiving the response from the hardware component, the response including an encrypted nonce;
logic for decrypting the response using a secret key as input to a symmetric cryptographic algorithm, the decryption providing the nonce; and
logic for validating the response,
wherein the identity exchange is a component identity exchange that uses a symmetric cryptography method.

40. The PIM of claim 29, wherein the logic for performing the identity exchange includes,
logic for receiving a challenge from the hardware component, the challenge including a nonce;
logic for computing a first digest using a one-way hash algorithm computed over the nonce and a secret key; and
logic for transmitting a response to the hardware component, the response including the first digest,
wherein the identity exchange is a platform identity exchange that uses a one-way hash method.

41. The PIM of claim 29, wherein the logic for performing the identity exchange includes,
logic for transmitting a challenge to the hardware component, the challenge including a nonce;
logic for receiving a response from the hardware component, the response including a first digest generated by the hardware component using a one-way hash algorithm computed over the nonce and a secret key;
logic for computing a second digest using a one-way hash algorithm computed over the nonce and a secret key; and
logic for validating the response,
wherein the identity exchange is a component identity exchange that uses a one-way hash method.

42. A hardware component to be bound with a platform, comprising:
logic for establishing a cryptographic binding between the platform and the hardware component, the cryptographic binding being registration of cryptographic keys between the platform and the hardware component; and
logic for performing an identity exchange between the platform and the hardware component using the cryptographic keys as inputs to cryptographic operations, the identity exchange enabling a challenger to verify the identity of a responder.

43. The hardware component of claim 42, wherein the logic for establishing the cryptographic binding between the platform and the hardware component includes,
logic for registering asymmetric public keys.

44. The hardware component of claim 42, wherein the logic for establishing the cryptographic binding between the platform and the hardware component includes,
logic for providing a secret key to the hardware component through a secure administrative path,
wherein the identity exchange uses one of a symmetric cryptography method and a one-way hash method.

45. The hardware component of claim 42, wherein the logic for establishing the cryptographic binding between the platform and the hardware component includes,
logic for performing a secret key exchange between the platform and the hardware component,
wherein the identity exchange uses one of a symmetric cryptography method and a one-way hash method.

46. The hardware component of claim 42, wherein the logic for performing the secret key exchange includes,
logic for receiving an encrypted secret key;
logic for decrypting the encrypted secret key using an asymmetric private key; and
logic for storing the secret key.

47. The hardware component of claim 45, wherein the logic for performing the secret key exchange includes,
logic for receiving an asymmetric public key; and
logic for validating an asymmetric public key using asymmetric public key registration information.

48. The hardware component of claim 42, wherein the logic for performing the identity exchange includes,
logic for receiving a challenge from the platform, the challenge including a nonce;
logic for encrypting the nonce using an asymmetric private key as input to an asymmetric cryptographic algorithm; and
logic for transmitting a response to the platform, the response including the encrypted nonce,
wherein the identity exchange is a component identity exchange that uses an asymmetric cryptography method.

49. The hardware component of claim 42, wherein the logic for performing the identity exchange includes,
logic for transmitting a challenge to the platform, the challenge including a nonce;
logic for receiving a response from the platform, the response including the nonce encrypted using an asymmetric private key;
logic for decrypting the encrypted nonce using an asymmetric public key; and
logic for validating the response,
wherein the identity exchange is a platform identity exchange that uses an asymmetric cryptography method.

50. The hardware component of claim 42, wherein the logic for performing the identity exchange includes,
logic for receiving an asymmetric public key; and
logic for validating an asymmetric public key using asymmetric public key registration information,
wherein the identity exchange uses an asymmetric cryptography method.

51. The hardware component of claim 42, wherein the logic for performing the identity exchange includes,
logic for receiving a challenge from the platform, the challenge including a nonce;
logic for encrypting the nonce using a secret key as input to a symmetric cryptographic algorithm, the encryption providing an encrypted nonce; and
logic for transmitting a response to the platform, the response including the encrypted nonce,
wherein the identity exchange is a component identity exchange that uses a symmetric cryptography method.

52. The hardware component of claim 42, wherein the logic for performing the identity exchange includes,
logic for transmitting a challenge to the platform, the challenge including a nonce;
logic for receiving the response from the platform, the response including an encrypted nonce;
logic for decrypting the response using a secret key as input to a symmetric cryptographic algorithm, the decryption providing the nonce; and
logic for validating the response,
wherein the identity exchange is a platform identity exchange that uses a symmetric cryptography method.

53. The hardware component of claim 42, wherein the logic for performing the identity exchange includes,
logic for receiving a challenge from the platform, the challenge including a nonce;
logic for computing a first digest using a one-way hash algorithm computed over the nonce and a secret key; and
logic for transmitting a response to the platform, the response including the first digest,
wherein the identity exchange is a component identity exchange that uses a one-way hash method.

54. The hardware component of claim 42, wherein the logic for performing the identity exchange includes,
logic for transmitting a challenge to the platform, the challenge including a nonce;
logic for receiving a response from the platform, the response including a first digest generated by the platform using a one-way hash algorithm computed over the nonce and a secret key;
logic for computing a second digest using a one-way hash algorithm computed over the nonce and a secret key; and
logic for validating the response,
wherein the identity exchange is a platform identity exchange that uses a one-way hash method.

55. A system for binding a hardware component and a platform, comprising:
a platform including,
logic for establishing a cryptographic binding between the hardware component and the platform, the cryptographic binding being registration of cryptographic keys between the hardware component and the platform, and
logic for performing an identity exchange between the hardware component and the platform using the cryptographic keys as inputs to cryptographic operations, the identity exchange enabling a challenger to verify the identity of a responder; and
the hardware component in communication with the platform.

56. The system of claim 55, wherein the hardware component includes,
logic for establishing the cryptographic binding between the hardware component and the platform, the cryptographic binding being registration of cryptographic keys between the hardware component and the platform; and
logic for performing the identity exchange between the hardware component and the platform using the cryptographic keys as inputs to cryptographic operations, the identity exchange enabling the challenger to verify the identity of the responder.

57. The system of claim 55, wherein the platform incorporates a platform identity module (PIM).

58. The system of claim 57, further comprising:
a central processing unit in communication with the PIM and the hardware component.

59. The system of claim 55, wherein the hardware component is defined by one of a chip, a peripheral component interconnect (PCI) card, a PCI-X card, a PCI-Express card, an infiniband terminal communications adapter, a mezzanine card, a network appliance, a platform, a storage system, a storage subsystem, a printer, a keyboard, a mouse, a mobile phone, a personal data assistant, a service processor provided to allow management of the platform, and a peripheral.

60. The system of claim 57, wherein the PIM is defined by one of a chip, a chip set, a board, a protected logic within a processor, and a protected logic within another hardware component that is part of the platform.

61. The system of claim 57, wherein the PIM is physically attached to the platform.

62. The system of claim 57, wherein the PIM is defined by one of a Trusted Computing Group compliant trusted platform module (TPM) and a Federal Information Processing Standards (FIPS) 140-2 compliant cryptographic module.

63. The system of claim 57, wherein the PIM includes a secure cryptographic key store and a cryptographic engine configured to operate on keys.
